(19) United States
(12) Patent Application Publication
(10) Pub. No.: US 2002/0116323 A1
(43) Pub. Date: Aug. 22, 2002

(54) Method and apparatus for providing loan information to multiple parties

(76) Inventor: Peter A. Schnall, Falls Church, VA (US)

Correspondence Address: FINNEGAN, HENDERSON, FARABOW, GARRETT &, DUNNER LLP, 1300 I STREET, NW, WASHINGTON, DC, 20005, US

(21) Appl. No.: 09/784,001

(22) Filed: Feb. 16, 2001

(51) Int. Cl. G06F 17/60

(52) U.S. Cl. 705/38

(57) ABSTRACT

A method and apparatus are provided of providing loan information to at least two parties. The disclosed method and apparatus provides loan data on a loan made to a primary party wherein the loan has a secondary party, such as a co-signer or guarantor. The method and apparatus generates a primary report including loan information on the loan and transmits the information in the primary report to the primary party. Next, the method and apparatus are used to generate a secondary report, including information related to the primary report, and to transmit the secondary report to the secondary party. The secondary report optionally may include financial information on the primary party receiving the loan and responsible for making payment on the loan amount.

### RELATED APPLICATION

The following identified U.S. patent application is relied upon and is incorporated by reference in its entirety in this application:

U.S. patent application Ser. No. ______, entitled “METHOD AND APPARATUS FOR MONITORING GUARANTEED LOANS AND NOTIFYING GUARANTORS,” by Peter Schnall, filed on the same date herewith.

### BACKGROUND OF THE INVENTION

I. Field of the Invention

This invention generally relates to financial data processing systems and, more particularly, to a method and apparatus for providing loan information to multiple parties.

II. Background and Material Information

A large number of lending institutions lend money to individuals and legal entities such as corporations and allow them to payback the money over a period of time. These loans can be made to facilitate the financing or purchase of cars, education, homes, home appliances, building construction and other items. Keeping current with any of these different types of loans requires that the party receiving the loan diligently pay each installment on the loan over the term of the loan.

On occasion, a person receiving the loan may forget to make a payment on a loan or may be unable to pay for their bill. The person responsible for paying the bill may be charged late fees for failing to pay the bill, in addition to the installment payment on the loan. The lending institution may incur additional costs associated with attempting to get payment of the bill. For example, the lending institution may be required to hire a collection agency to collect the bills. In some cases, the lending institution will be able to collect the debts and/or fines on overdue payments. In other situations, however, the lending institution may fail to collect the debts and thus will incur losses. For example, a student unfamiliar with managing expenses and timely paying of bills and other obligations may be unable to make the monthly loan payments and thereby incur corresponding fines. This situation often occurs because parents and others cannot closely monitor the bills and warn the student of overextending their expenses and risking their ability to pay off their loans.

In view of the foregoing limitations, there is a need in the financial industry to improve the ability of parties to monitor loans and to avoid or decrease the costs of debt collection and losses in making loans.

### SUMMARY OF THE INVENTION

In view of the foregoing, a method and apparatus are provided, consistent with the features of the invention, of providing loan information to at least two parties. The disclosed method and apparatus provides loan data on a loan made to a primary party wherein the loan has an associated secondary party, such as a co-signer or individual or entity related to the party or otherwise having a interest in the timely payment of the loan. The method and apparatus generates a primary message which may be in the form of a report including information about the loan and transmits the information in the primary message to the primary party. Next, the method and apparatus are used to generate a secondary message, which may comprise a report, including information related to the primary message, and to transmit the information to the secondary party. The secondary message may also include financial information about the primary party receiving the loan and responsible for making payment on the loan amount. Such messages may be generated at predetermined, or scheduled, time intervals and/or their operation may be triggered by predetermined conditions associated with the progress of repayment of the loan.

### BRIEF DESCRIPTION OF DRAWINGS

The accompanying drawings, which are incorporated in and constitute a part of this specification, illustrate the various features and embodiments of the invention and, together with the detailed description, serve to explain the advantages and principles of the invention. In the accompanying drawings:

FIG. 1 is a block diagram of a financial data processing system consistent with the features of the invention;

FIG. 2 is a block diagram of components used in a financial data processing system to provide loan information, in accordance with the features of present invention; and

FIG. 3 is an exemplary flow chart indicating the various processes and operations for providing loan information, in accordance with the features of the present invention.

### DETAILED DESCRIPTION

Reference will now be made in detail to systems and methods, consistent with the present invention, that are illustrated in the accompanying drawings. Wherever possible, the same reference numbers in different figures refer to the same or similar parts.

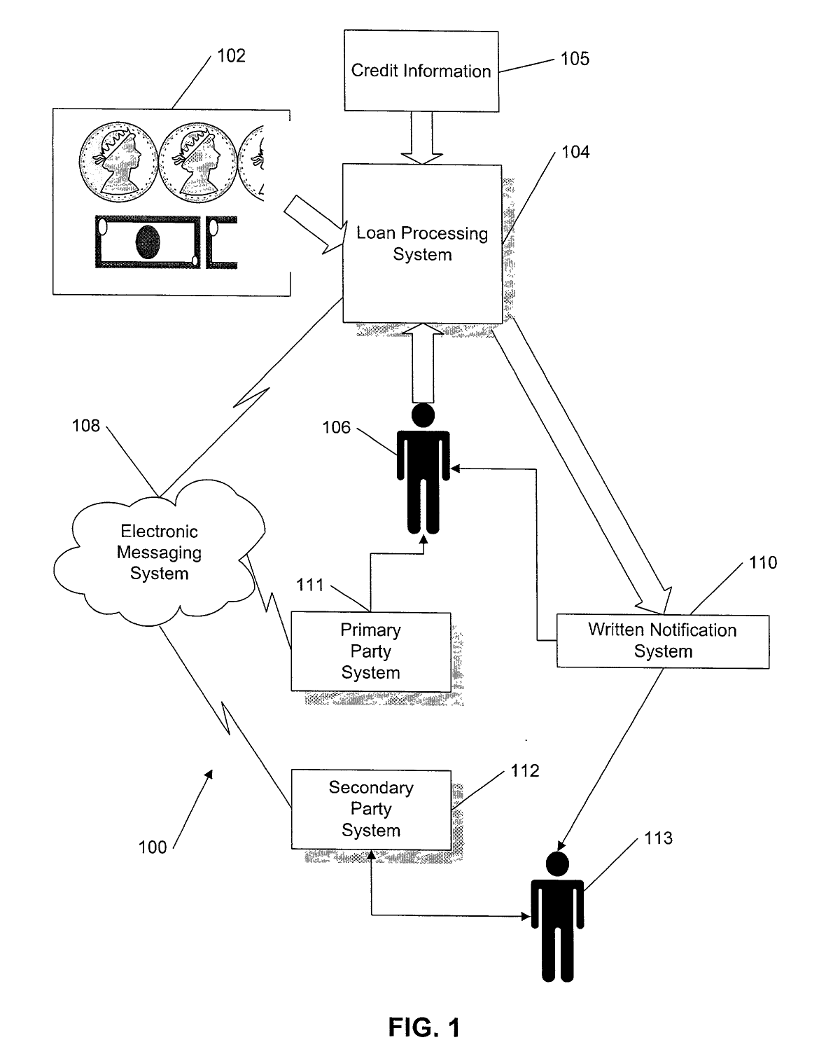

FIG. 1 is a block diagram of a financial data processing system 100 consistent with the features of the present invention. System 100 includes a loan processing system 104, an electronic messaging system 108, a written notification system 110, a primary party system 111, and a secondary party system 112. Loan processing system 104, primary party system 111, and secondary party system 112 may comprise general purpose computers or computer-based subsystems associated with larger computer systems, such as portable digital assistants (PDA) or other handheld type computing devices.

There are several methods to integrate loan processing system 104, primary party system 111, and secondary party system 112 into existing or “legacy” computer systems of a financial institution or network. For example, these systems can be connected to an existing computer system using a standard network protocol, such as TCP/IP. In addition, data being analyzed and used by loan processing system 104 can be transferred over a TCP/IP “socket” between loan processing system 104 and the legacy computer system(s). Alternatively, data can be transferred between loan processing system 104 and each existing computer system using data stored on a tape or floppy disk storage device.

Loan processing system 104 receives information about a primary party 106 and determines if the primary party qualifies to receive a loan based on credit information 105 and loan information 102. Primary party 106 can be a person, such as a student, an organization such as a corporation or partnership, or any other entity capable of receiving a loan. Credit information 105 includes information, such as a credit report or history, retrieved from one or more credit reporting agencies that indicate the creditworthiness of an entity or individual, such as primary party 106. Loan information 102 includes loan qualification information, information indicating the term and rate of the loan, the monthly payments required to pay off the loan, and historical payment information associated with the loan.

If loan processing system 104 determines that primary party 106 does not qualify individually for the loan, then credit information associated with a secondary party 113 may be analyzed to assist in approving the loan. Secondary party 113 can be a person, an organization such as a corporation or partnership, or any other entity capable of assisting primary party 106 qualify for a loan, such as by acting as a guarantor. If loan processing system 104 determines that primary party 106 qualifies for the loan without a co-signer or guarantor, then the loan may be approved for primary party 106 without the involvement of a secondary party. However, in such case, there may exist a secondary party 113 that is associated with primary party 106 and/or otherwise interested in monitoring loans to primary party 106 to make sure that they are paid in a timely manner. For example, primary party 106 may be a student and secondary party 113 may be the student's parents. Alternatively, primary party 106 and secondary party 113 may be related as spouses. With the features of the present invention, the designated secondary party can receive a copy of the primary party's loan information and remind the primary party to make timely payments.

Once a loan has been issued to primary party 106, loan information 102 may be regularly updated to provide current information on the loan. The current loan information may include, for example, the current outstanding balance of the loan, the last payment amount and date, and late payments or penalties on the loan. Loan information 102 may also include contact information for transmitting information about the loan to primary party 106 and secondary party 113.

Loan processing system 104 processes loan information 102 associated with a loan made to primary party 106 and determines if notification should be sent to secondary party 113. If more than one secondary party is associated with the loan, a separate notification can be sent to each party. These notifications can be sent to each secondary party 113 using written notification system 110 or sent through secondary party system 112 using electronic messaging system 108, including messaging via the Internet. Secondary party system 112 can be a general purpose computer or a specialized device, such as a wireless phone, capable of receiving electronic messages. Electronic messaging system 108 may process various electronic messages including e-mail, facsimile, telephone messages and/or electronic pages, to send notification to secondary party 113, including receiving the same over the Internet by accessing a Web site. Written notification system 110 can be an automated system or a system controlled by personnel for sending written notification by letter, postcard or other printed form through a mail or courier system to secondary party 113. Both forms of notification may be used in accordance with a feature of the invention, the preferred form of receiving notification may be selected by secondary party 113.

According to an aspect of the invention, notification is sent to both the primary party 106 and secondary party 113 at predetermined time intervals and includes loan information processed by loan processing system 104. By way of example, loan processing system 104 may send a notification to primary party 106 and secondary party 113 on a regularly scheduled basis, such as once a month, when a payment or loan installment is due. This notification allows secondary party 113 to monitor the outstanding loan amount and when payment on the loan amount is due from the primary party 106. The notification may also include other loan information indicating, for example, the amount of the last payment, when a payment was missed or the amount of penalties that were incurred.

According to another aspect of the invention, notification may be sent to both primary party 106 and secondary party 113, or either of them, upon the occurrence of certain “trigger” events. Such notification may be in addition to, the notifications that are sent at the predetermined time intervals, as described above. For example, such a trigger event may be the failure to make a timely payment on the loan. Instead of waiting for the next regularly scheduled notification period, which may be a month away, the system will generate a notification shortly after the missed payment date. If payment is not made promptly, additional notification messages can be generated by the system. The frequency of such triggered notifications can be established by the lender, or even by the parties themselves, as a reminder mechanism that a payment has been missed.

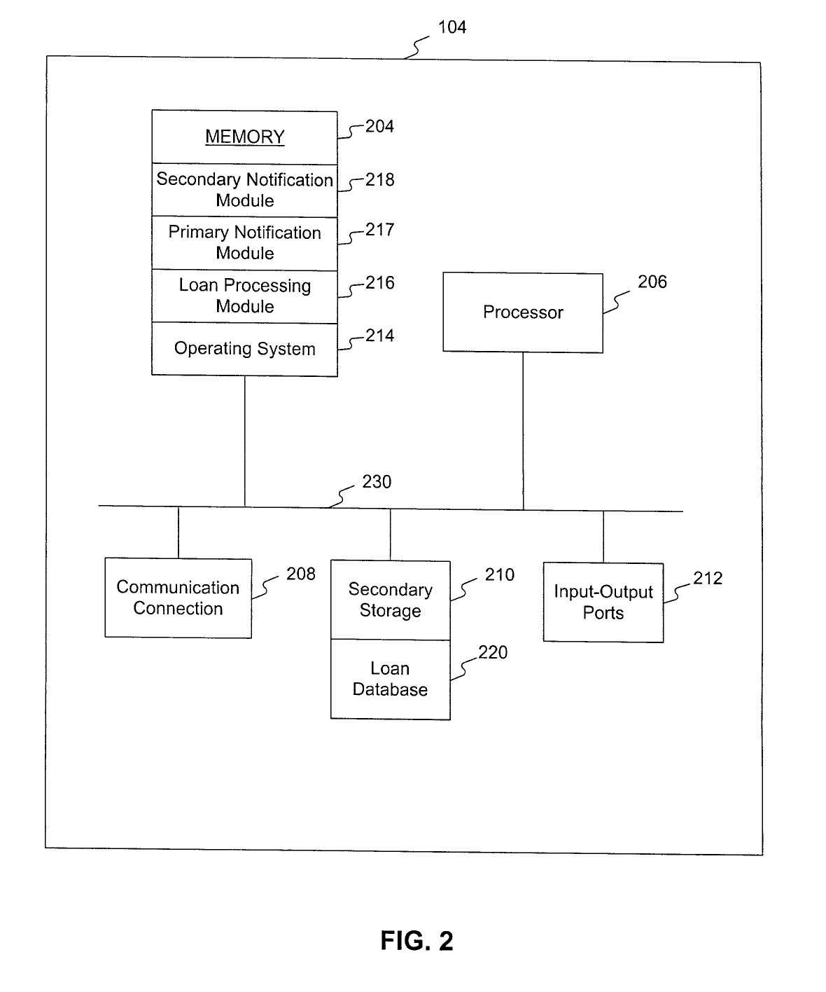

FIG. 2 is an exemplary block diagram of the components that can be used to implement the loan processing system 104 and provide notification of the loan to secondary party 113. Second party notification may be integrated with existing or legacy systems that provide primary party notification by using a TCP/IP protocol, for example. Preferably, loan processing system 104 includes a memory 204, a processor 206, a communication connection 208, a secondary storage 210, and input-output ports 212 that are inter-connected by a bus infrastructure or network 230. In accordance with an aspect of the invention, communication connection 208 may include communication devices compatible with asynchronous transfer mode (ATM), Fiber Distributed Data Interface (FDDI), Copper Distributed Data Interface (CDDI) or other equivalent protocols. CDDI is the implementation of FDDI protocols over shielded twisted pair (STP) and unshielded twisted pair (UTP) cabling. Secondary storage 210 can be a hard disk or other permanent storage device used to hold information used in processing information with processor 206. Input/output ports 212 may include serial ports or parallel ports for communication with a console, keyboard, mouse, printer or other devices. Although these components are highlighted, other components not specifically included herein may be included as part of different implementations of loan processing system 104 that are consistent with the teachings of the invention.

As illustrated in FIG. 2, memory 204 may be configured to store an operating system 214, a loan processing module 216, a primary notification module 217 and a secondary notification module 218 for execution by processor 206. Operating system 214 manages resources such as memory 204 and secondary storage 210, as well as the allocation of bandwidth through communication connection 208. Operating system 214 also controls execution of modules on processor 206 and location of modules in memory 204.

Loan processing module 216 may include all of the necessary data processing tasks associated with loans and other debt instruments. These tasks include gathering information on loan recipients such as creditworthiness, determining maximum-qualified loan amounts, tracking payment of loans, and identifying loans made with a co-signer.

The data associated with the credit processing performed by loan processing module 216 can be stored in and accessed from a loan database 220. Loan database 220 may be organized and stored within secondary storage 210. Loan database 220 includes raw data on loans made by the lending institution (such as loan information 102) and may also includes data from credit reporting agencies (such as credit information 105) imported through communication connection 208. This loan information can be stored as raw credit and loan information within loan database 220 and/or may include a point-score credit rating system used by the credit reporting industries such as Fair Issac (FICO). Preferably, at least one table in loan database 220 will also indicate whether a loan has a cosigner. Contact information and notification preferences for each secondary party can also be provided in the loan database 220, in accordance with an aspect of the invention.

Secondary notification module 218 includes data processing tasks, consistent with the features of the invention, for sending notification to secondary party 113 on the state of a particular loan. Notification module 218 can be developed in a database programming language such as structured query language (SQL) or 4GL to access loan database 220, analyze the information and generate notification using loan processing system 104. Alternatively, notification module 218 can be developed using object-oriented programming languages such as Java or non-object oriented programming languages such as C. In operation, notification module 218 obtains loan information from loan database 220. For example, notification module 218 can use SQL statements to retrieve the appropriate fields of information from loan database 220 corresponding to the predetermined time periods the loan information is to be generated. Similarly, primary notification module 217 includes data processing tasks, consistent with the features of the invention, for sending notification to the primary party 106 on the state of a particular loan. Primary notification module 217 can be developed in a database programming language such as structured query language (SQL) or 4GL to access loan database 220, analyze the information and generate notification using loan processing system 104. Alternatively, primary notification module 217 can be developed using object-oriented programming languages such as Java or non-object oriented programming languages such as C. In operation, primary notification module 217 obtains loan information from loan database 220. For example, primary notification module 217 can use SQL statements to retrieve the appropriate fields of information from loan database 220 corresponding to the predetermined time periods the loan information is to be generated. Information about the loan provided to the primary party 106 typically may contain more detail than that provided to the secondary party 113. As discussed above, the loan information can be transferred over a network connection or may be uploaded to a different computer using a secondary storage device, such as a tape or floppy-disk, and stored in loan database 220. As discussed above, the loan information can be transferred over a network connection or may be uploaded to a different computer using a secondary storage device, such as a tape or floppy-disk, and stored in loan database 220.

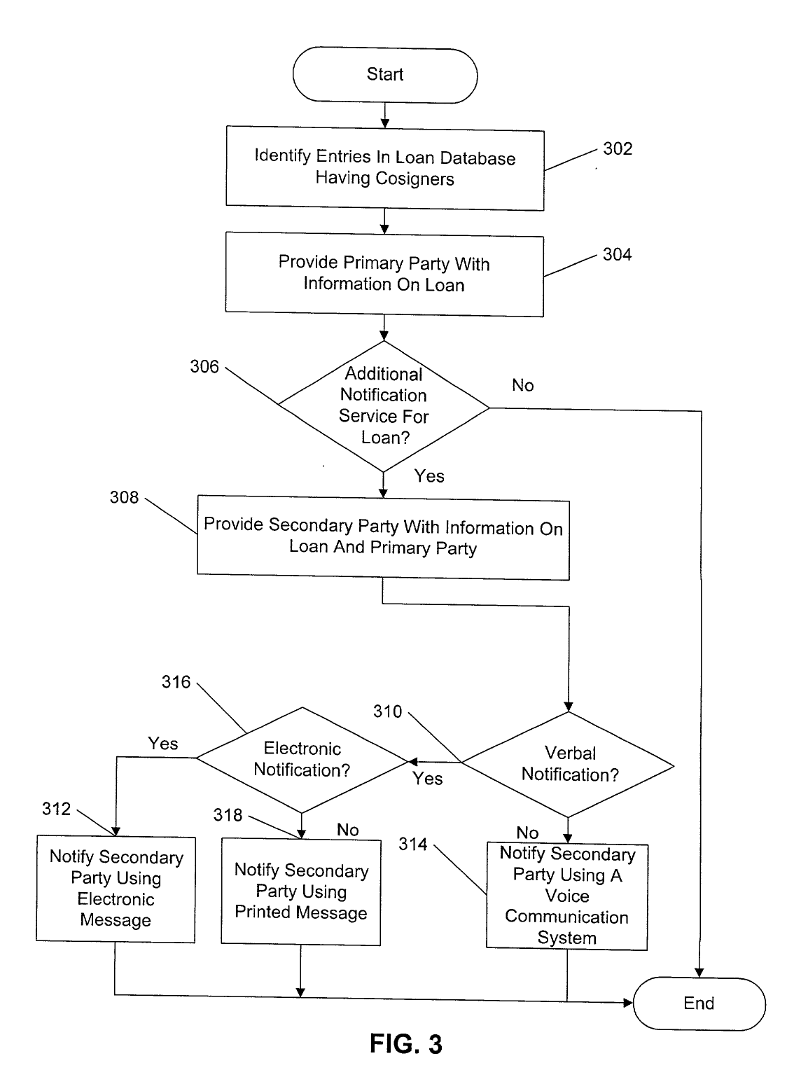

FIG. 3 is an exemplary flow chart indicating the various processes and operations performed by notification module 218 to transmit notification to primary party 106 and secondary party 113.

As illustrated in FIG. 3, notification module 218 is initialized and executed by processor 206 in FIG. 2 to identify each loan having a secondary party (step 302). Notification module 218 may be initialized and executed on a periodic basis such as one or more scheduled time intervals each month or continuous basis each time an update is applied to loan database 220.

As described earlier, notification module 218 may also be initialized and executed at times other than the regularly scheduled intervals, by a triggering event, such as when a payment is missed. One or more such notifications may be made in the period between scheduled time intervals. The notifications may increase in frequency to impress upon the borrower the fact that a payment was missed or other factors necessitating additional messages have arisen.

In order to identify loans with a secondary party, notification module 218 may access the appropriate table in loan database 220 identifying loans with co-signers, guarantors or other entities identified as being associated with the loan. The table in loan database 220 may include a record entry for each loan with information on the loan recipient, the co-signers, guarantors or other type of secondary party on the loan (if any) and the contact information for each secondary party, such as an e-mail address or a postal address. Additionally, notification preferences may be provided to identify the type of information desired and the preferred form of notification (e.g., electronic, written or none) to send secondary party 113. The notification preferences may also be used to determine if notification service is active for a particular loan.

Notification module 218 provides primary party 106 with information on the loan (step 304). The loan information that is sent to primary party 106 may take the form of a primary party message or a notification, such as a report, that includes information concerning the status (e.g., outstanding balance, payment due date, etc.) and/or terms of the loan. Notification to the primary party may be sent using several techniques, including via e-mail, paging, Internet access, or by conventional mail. This loan information can include information on the terms of the loan, the payoff amount for the loan, the interest accrued year-to-date and other information concerning the loan. Generally, primary party 106 receives this type of information on a regular basis such as once every month when the loan payment is due.

For each loan identified as having a secondary party 113, notification module 218 determines if loan servicing associated with the loan includes notifying secondary party 113 with the loan information (step 306). Some secondary parties may wish to opt out of receiving notification for various reasons, including to save money if a premium is charged by the lending institution for the service. If there is no additional notification service for the identified loan, then servicing of that loan by notification module 218 is terminated or skipped, and the next loan is analyzed.

As further shown in FIG. 3, for each loan having additional notification service, notification module 218 collects loan and/or credit information and transmits the results to secondary party 113. As indicated above, the secondary party may be a co-signer or guarantor of the loan or may be a party interested in the status of the loan or loan payment. Notification module 218 may provide each secondary party 113 with information on the status of the loan (e.g., outstanding balance, payment due date, etc.) and information concerning primary party 106 who received the loan (step 308). For example, notification module 218 may collect credit history and other credit information about primary party 106 and include this information in the message or notification, such as a report provided to secondary party 113. The primary and secondary modules, 217, 218 respectively, are hard coded. A TCP/IP protocol is used to transmit the data. Alternatively, the data may be sent by e-mail, paging, by conventional mail or via courier. This additional information about primary party 106 may help secondary party 113 analyze the loan and monitor payment of the loan. The loan information that is sent to the secondary party 113 may have the same or a similar format as the primary party message that is sent to primary party 106.

Once the information for secondary party 113 is collected, notification module 218 provides the information to secondary party 113. The information may be sent to secondary party 113 through various types of notification techniques. For example, if secondary party 113 requests verbal notification (step 310), then the lending institution or an automated message center will verbally notify secondary party 113 (step 314). The verbal notification may be sent to secondary party 113 using a voice communication system, such as a telephony based network. If, however, secondary party 113 requests to be notified electronically (step 316), then notification may be directed to electronic messaging system 108 where an electronic message or e-mail message is generated and sent to secondary party 113 (step 312). Notification may also be received through the Internet by the secondary party accessing a Web site having appropriate security mechanisms, such as requiring a password and accessing the relevant information. The electronic message includes information on the loan and/or credit information on primary party 106. Alternatively, if secondary party 113 requests written notification then notification module 218 may cause written notification system 110 to generate a printed notification and send the notification to secondary party 113 through the mail (step 318). The notification may include loan information and credit information about primary party 106. Alternatively, the lending institution may decide the type of notification to transmit rather than having secondary party 113 decide the appropriate type of notification.

While specific embodiments have been described herein for purposes of illustration, various modifications may be made without departing from the spirit and scope of the invention as set forth in the claims. For example, the features consistent with the invention are not limited to guaranteed loans or loans with co-signers. Notification may also be used by lending institutions and other organizations to track any type of loan issued to the primary party receiving a loan. The notification may be used by a financial institution to better monitor the payments on a loan and the corresponding risks associated with the loan. By providing such notification, loan collection costs and losses associated with bad loans can be reduced. Accordingly, the invention is not limited to the above described embodiments, but instead is defined by the appended claims in light of their full scope of equivalents.

What is claimed is:

1. A method, executed on a data processing system, of providing loan information to at least two parties, comprising:
providing loan data on a loan made to a primary party wherein the loan has a secondary party as a cosigner;
generating a primary message including loan information on the loan;
transmitting the primary message to the primary party;
generating a secondary message including the primary message; and
transmitting the secondary message to the secondary party.

2. The method of claim 1 further comprising adding financial information related to the primary party in the secondary message.

3. The method of claim 2 further comprising including information related to the credit worthiness of the primary party in the financial information.

4. The method of claim 1, after the providing and prior to the generating a primary message, further comprising determining if a secondary message should be generated for a secondary party.

5. The method of claim 1, wherein the transmitting further comprises transmitting an electronic message including the corresponding primary or secondary message.

6. The method of claim 1, wherein the transmitting further comprises transmitting a written notice including the corresponding primary or secondary message.

7. The method of claim 1, wherein the transmitting further comprises transmitting a verbal message including the corresponding primary or secondary message.

8. The method of claim 1, wherein
the primary and secondary messages are transmitted at predetermined time intervals.

9. The method of claim 8, wherein
additional messages comprising at least one of a primary and secondary message are transmitted in addition to the messages transmitted at predetermined time intervals.

10. An apparatus for providing loan information to at least two parties, comprising:
a processor; and
a memory containing instructions capable of executing on the processor that provides loan information on a loan made to a primary party wherein the loan has a secondary party as a cosigner, generates a primary message including loan information on the loan, transmits the primary message to the primary party, generates a secondary message including the primary message, and transmits the secondary message to the secondary party.

11. The apparatus in claim 10 further comprising instructions for adding financial information related to the primary party in the secondary message.

12. The apparatus in claim 11 further comprising instructions for including information related to the credit worthiness of the primary party in the financial information.

13. The apparatus in claim 10 further comprising instructions that determine if a secondary message should be generated for a secondary party.

14. The apparatus in claim 10 further comprising instructions that transmit an electronic message including the corresponding primary message or secondary message.

15. The apparatus in claim 10 further comprising instructions that transmit a written notice including the corresponding primary message or secondary message.

16. The apparatus in claim 10 further comprising instructions that transmit a verbal message including the corresponding primary message or secondary message.

17. The apparatus of claim 13, wherein
the primary and secondary messages are transmitted at predetermined time intervals.

18. The apparatus of claim 17, wherein
additional messages comprising at least one of a primary and secondary message are transmitted in addition to the messages transmitted at predetermined time intervals.

19. An apparatus for providing loan information to at least two parties, comprising:
a providing module capable of providing loan data on a loan made to a primary party wherein the loan has a secondary party as a cosigner;
a generation module capable of generating a primary message including loan information on the loan;
a transmission module capable of transmitting the primary message to the primary party;
a generation module capable of generating a secondary message including the primary message; and
transmitting the secondary message to the secondary party.

20. The apparatus of claim 19, wherein
the primary and secondary messages are transmitted at predetermined time intervals.

21. The apparatus of claim 20, wherein
additional messages comprising at least one of a primary and secondary message are transmitted in addition to the messages transmitted at predetermined time intervals.

22. An apparatus for providing loan information to at least two parties, comprising:
means for providing loan data on a loan made to a primary party wherein the loan has a secondary party as a cosigner;
means for generating a primary message including loan information on the loan;
means for transmitting the primary message to the primary party;
means for generating a secondary message including the primary message; and
means for transmitting the secondary message to the secondary party.

23. The apparatus of claim 22, wherein
the primary and secondary messages are transmitted at predetermined time intervals.

24. The method of claim 23, wherein
additional messages comprising at least a primary and secondary message are transmitted in addition to the messages transmitted at predetermined time intervals.

25. A computer program product capable of providing loan information to at least two parties, the computer program product comprising program code capable of:
providing loan data on a loan made to a primary party wherein the loan has a secondary party as a cosigner;
generating a primary message including loan information on the loan;
transmitting the primary message to the primary party;
generating a secondary message including the primary message; and
transmitting the secondary message to the secondary party.

26. The computer program product of claim 25, wherein
the primary and secondary messages are transmitted at predetermined time intervals.

27. The computer program product of claim 26, wherein
additional messages comprising at least one of a primary and secondary message are transmitted in addition to the messages transmitted at predetermined time intervals.
